(19) United States
(12) Patent Application Publication
(10) Pub. No.: US 2011/0050671 A1
(43) Pub. Date: Mar. 3, 2011

(54) NON-VOLATILE DISPLAY MODULE AND NON-VOLATILE DISPLAY APPARATUS

(75) Inventor: Wen-Jyh Sah, Tainan City (TW)

(73) Assignee: GIGNO TECHNOLOGY CO., LTD., Taipei City (TW)

(21) Appl. No.: 12/859,208

(22) Filed: Aug. 18, 2010

(30) Foreign Application Priority Data
Aug. 27, 2009 (TW) 098128817

(51) Int. Cl. G09G 5/00

(52) U.S. Cl. 345/211

(57) ABSTRACT

A non-volatile display module has a display panel and a driving circuit. The display panel has a substrate disposed with at least one scan line, at least one data line and at least one thin film transistor (TFT). The TFT is located at an interlaced area of the scan line and data line. The driving circuit has a memory unit, a voltage level generating unit and a voltage level selecting unit. The memory unit receives and stores at least one image control signal in accordance with a clock signal. The voltage level generating unit generates a plurality of voltage-level signals. The voltage level selecting unit is electrically connected with the scan line, the data line, the memory unit and the voltage level generating unit, and outputs one of the voltage-level signals to one scan line or one data line in accordance with the image control signal. A non-volatile display apparatus is also disclosed.

### CROSS REFERENCE TO RELATED APPLICATIONS

This Non-provisional application claims priority under 35 U.S.C. §119(a) on Patent Application No(s). 098128817 filed in Taiwan, Republic of China on Aug. 27, 2009, the entire contents of which are hereby incorporated by reference.

### BACKGROUND OF THE INVENTION

1. Field of Invention

The present invention is related to a display module and apparatus, and in particular, to a non-volatile display module and apparatus.

2. Related Art

The display apparatuses have been sufficiently improved from the traditional CRT display apparatuses. For example, the LCD apparatus, OLED display apparatus, and E-paper display apparatus are developed recently, and they all have the advantages of reduced volume and weight. Thus, they can be widely applied to the communication products, information products and consumer electronics products.

As shown in FIG. 1, a conventional display apparatus, such as an LCD display apparatus, includes an LCD display module 1, which has a LCD panel 11, a data driving circuit 12, and a scan driving circuit 13. The data driving circuit 12 is electrically connected with the LCD panel 11 through a plurality of data lines D₁₁ to D₁ₙ, and the scan driving circuit 13 is electrically connected with the LCD panel 11 through a plurality of scan lines S₁₁ to S₁ₘ.

As shown in FIG. 2, the data driving circuit 12 includes a shift register unit 122, a primary latch unit 123, a secondary latch unit 124, and a level shifter unit 125. The shift register unit 122 is electrically connected with the primary latch unit 123, and the secondary latch unit 124 is electrically connected with the primary latch unit 123 and the level shifter unit 125.

With reference to FIG. 2 and FIG. 3, the shift register unit 122 can generate shift register signals A₁₁ to A₁ₙ, according to a start pulse signal A₀₁ and a clock signal CK, and then outputs the shift register signals A₁₁ to A₁ₙ to the primary latch unit 123.

The primary latch unit 123 receives an image signal A₀₂ according to the shift register signals A₁₁ to A₁ₙ. The image signal A₀₂ includes a plurality of image data and is stored in the primary latch unit 123. The secondary latch unit 124 retrieves the image signal A₀₂ according to a latch enable signal A₀₃. The level shifter unit 125 transforms the image signal A₀₂, which is stored in the secondary latch unit 124, into a plurality of display signals, which are transmitted to the LCD panel 11 through the data lines D₁₁ to D₁ₙ correspondingly for displaying an image.

Due to the progress of technologies in this field, the non-volatile material, such as electrophoresis material, electrowetting material, cholesteric liquid crystal, or nematic liquid crystal, is successfully applied in the display apparatus. Generally speaking, the display apparatus including the non-volatile material has the features of small size and portable. If the above-mentioned data driving circuit 12 and scan driving circuit 13 can be integrated so as to reduce the amount of the components, the display apparatus can be manufactured with smaller or thinner size, or less weight, thereby decreasing the manufacturing cost.

Therefore, it is an important subject to provide a non-volatile display module and apparatus that have reduced amount of components.

### SUMMARY OF THE INVENTION

In view of the foregoing, an objective of the present invention is to provide a non-volatile display module and apparatus that have reduced amount of components.

To achieve the above, the present invention discloses a non-volatile display module including a display panel and a driving circuit. The display panel includes a substrate disposed with at least one scan line, at least one data line and at least one thin film transistor (TFT). The TFT is located at an interlaced area of the scan line and the data line. The driving circuit includes a memory unit, a voltage level generating unit and a voltage level selecting unit. The memory unit receives and stores at least one image control signal in accordance with a clock signal. The voltage level generating unit generates a plurality of voltage-level signals. The voltage level selecting unit is electrically connected with the scan line, the data line, the memory unit and the voltage level generating unit. The voltage level selecting unit outputs one of the voltage-level signals to the scan line or the data line in accordance with the image control signal.

In addition, the present invention also discloses a non-volatile display apparatus including a non-volatile display module. The non-volatile display module includes a display panel and a driving circuit. The driving circuit includes a memory unit, a voltage level generating unit, and a voltage level selecting unit. The memory unit receives at least one image control signal in accordance with a clock signal. The voltage level generating unit generates a plurality of voltage-level signals. The voltage level selecting unit is electrically connected with the scan line, the data line, the memory unit and the voltage level generating unit. The voltage level selecting unit outputs one of the voltage-level signals to the scan line or the data line in accordance with the image control signal.

As mentioned above, the non-volatile display module and apparatus of the invention have a driving circuit, which includes a memory unit, a voltage level generating unit and a voltage level selecting unit, for processing the signals transmitted through the scan line and data line, thereby generating the displayed image. Compared with the prior art, the non-volatile display apparatus of the invention can not only integrate the conventional separated scan driving circuit and data driving circuit, but also use the driving circuit with simpler structure to process the signals transmitted through the scan line and the data line. Thus, the non-volatile display module and apparatus of the present invention can be manufactured with reduced amount of components, thereby decreasing the manufacturing cost.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of the conventional display apparatus;

FIG. 2 is a schematic diagram showing the data driving circuit of the conventional display apparatus;

FIG. 3 is a timing chart of the data driving circuit of the conventional display apparatus;

FIG. 4 is a schematic diagram of a non-volatile display apparatus according to an embodiment of the invention;

FIG. 5, FIG. 6 and FIG. 7 are schematic diagrams respectively showing the circuit connection structures of the multiplexer and voltage level generating unit of the display apparatus of FIG. 4; and

FIG. 8 is a timing chart of the voltage level signal outputted by the voltage level generating unit of FIG. 7.

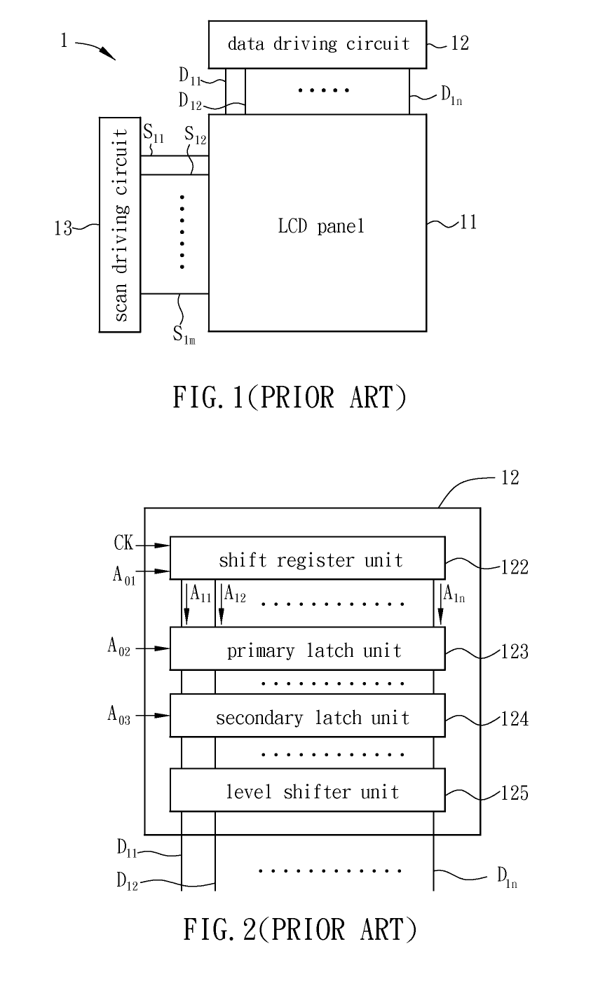

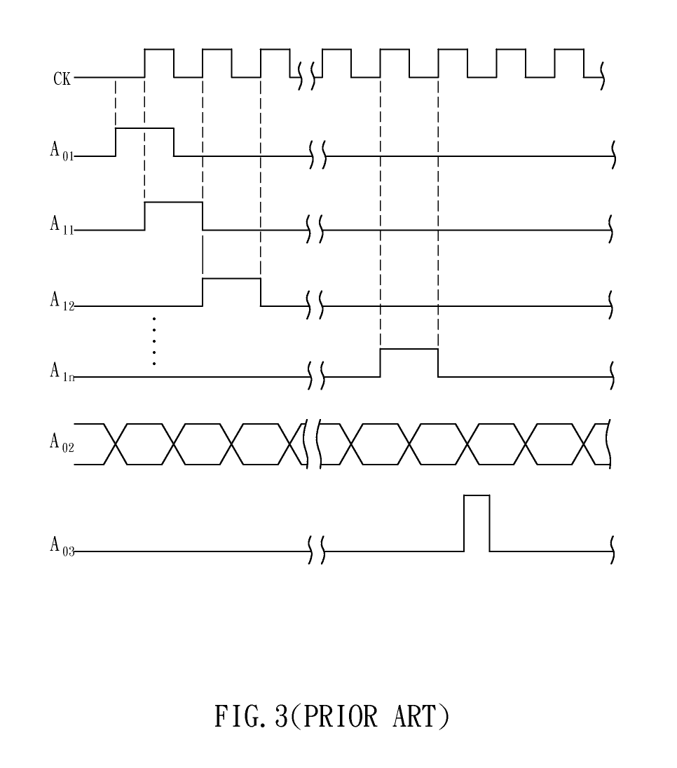

### DETAILED DESCRIPTION OF THE INVENTION

The present invention will be apparent from the following detailed description, which proceeds with reference to the accompanying drawings, wherein the same references relate to the same elements.

A non-volatile display apparatus means it has at least two stable states, so that it can be lasting in the stable state for several tens of milliseconds (ms) after removing the power source. Besides, the optical modulation material of the display apparatus may include electrophoresis solution, electrowetting material, cholesteric liquid crystal, or nematic liquid crystal.

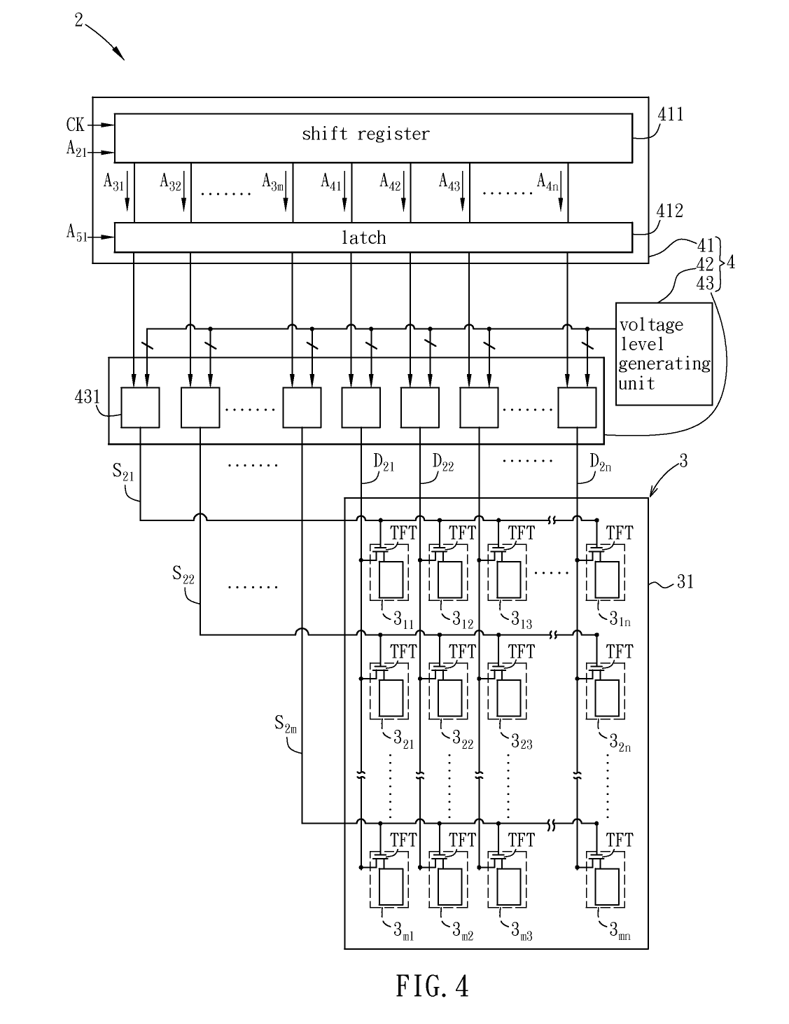

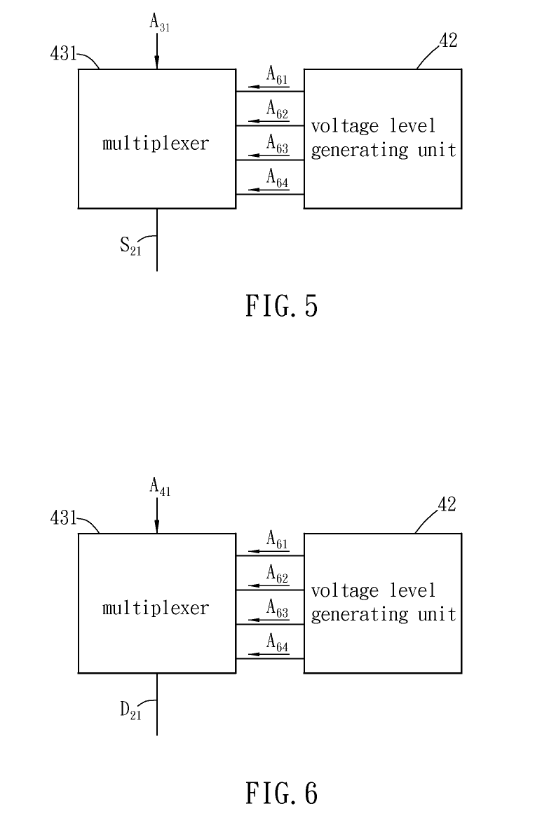

With reference to FIG. 4, a non-volatile display apparatus according to an embodiment of the invention includes a non-volatile display module 2, which includes a display panel 3 and a driving circuit 4. In the embodiment, the driving circuit 4 is electrically connected with the display panel 3 through a plurality of data lines D₂₁ to D₂ₙ and a plurality of scan lines S₂₁ to S₂ₘ.

The display panel 3 includes a substrate 31, at least one scan line, at least one data line, and at least one thin film transistor TFT. The thin film transistor TFT is located at an interlaced area of the scan line and the data line, and is electrically connected to an electrode. Herein, the interlaced as well as the thin film transistor TFT is called a pixel unit, and the pixel units can be arranged in a one-dimension array or a two-dimension array. In this embodiment, the display panel 3 includes a plurality of pixel units 3₁₁ to 3ₘₙ for example, and they are arranged in a two-dimension array. The scan lines S₂₁ to S₂ₘ and the data lines D₂₁ to D₂ₙ are crossly disposed on the display panel 3 to form a plurality of interlaced areas, which are disposed corresponding to the pixel units 3₁₁ to 3ₘₙ.

The driving circuit 4 includes a memory unit 41, a voltage level generating unit 42, and a voltage level selecting unit 43. The voltage level selecting unit 43 is electrically connected with the scan lines S₂₁ to S₂ₘ, the data lines D₂₁ to D₂ₙ, the memory unit 41 and the voltage level generating unit 42.

The memory unit 41 has a shift register 411 and a latch 412, which are electrically connected with each other, and the voltage level selecting unit 43 has at least one multiplexer. In this embodiment, the voltage level selecting unit 43 has a plurality of multiplexers 431, each of which is electrically connected with the memory unit 41, the voltage level generating unit 42 and the corresponding one of the scan lines S₂₁ to S₂ₘ or the data lines D₂₁ to D₂ₙ.

When the driving circuit 4 is enabled, the shift register receives an image control signal A₂₁ according to a clock signal CK. In this case, the image control signal A₂₁ includes a plurality of first driving signals A₃₁ to A₃ₘ and a plurality of second driving signals A₄₁ to A₄ₙ.

The latch 412 receives the first driving signals A₃₁ to A₃ₘ and the second driving signals A₄₁ to A₄ₙ according to a latch signal A₅₁, and then transmits them to the voltage level selecting unit 43. In more detailed, the shift register 411 receives the image control signal A₂₁ in series, and the latch 412 transmits the first driving signals A₃₁ to A₃ₘ and the second driving signals A₄₁ to A₄ₙ to the voltage level selecting unit 43 in parallel.

To simplify the following description, the voltage level selecting unit 43 cooperating with the voltage level generating unit 42, the multiplexer 431 and the scan line S₂₁ for transmitting one of the voltage level signals to the scan line S₂₁ according to the image control signal A₂₁ will be illustrated hereinbelow.

Referring to FIG. 5, the voltage level generating unit 42 outputs four voltage level signals A₆₁ to A₆₄ to the multiplexer 431. In this case, the voltage level generating unit 42 is, for example, a DC/DC voltage-level translator, and the voltage level signals A₆₁ to A₆₄ are all DC voltage signals (e.g. 30V, −10V, 20V and −5V).

In this case, the multiplexer 431 is disposed corresponding to the scan line S₂₁, so that the image control signal A₂₁ herein is the first driving signal A₃₁. The multiplexer 431 can transmit one of the voltage level signals A₆₁ to A₆₄ to the scan line S₂₁ according to the first driving signal A₃₁ for determining the voltage level of the scan signal transmitted by the scan line S₂₁. When the scan line S₂₁ transmits the scan signal with the voltage level of 30V or 20V, the transistor of the pixel unit 3₁₁ can be enabled; otherwise, when the scan line S₂₁ transmits the scan signal with the voltage level of −10V or −5V, the transistor of the pixel unit 3₁₁ can be disabled.

To be noted that the voltage level generating unit 42 generates only four voltage level signals A₆₁ to A₆₄ is for illustration only, and those skilled in the art should know that the output, such as the amount and levels of the outputted signals, of the voltage level generating unit 42 can be varied according to the demands.

In addition, part of the multiplexers 431 are electrically connected with the scan line S₂₁, and the other part of the multiplexers 431 are electrically connected with the data lines D₂₁ to D₂ₙ. To simplify the following description, the voltage level selecting unit 43 cooperating with the voltage level generating unit 42, the multiplexer 431 and the data line D₂₁ for transmitting one of the voltage level signals to the data line D₂₁ according to the image control signal A₂₁ will be illustrated hereinbelow.

Referring to FIG. 6, the voltage level generating unit 42 outputs four voltage level signals A₆₁ to A₆₄ to the multiplexer 431. In this case, the voltage level signals A₆₁ to A₆₄ are all DC voltage signals with the voltage levels of, for example, 30V, −10V, 20V and −5V.

In this case, the multiplexer 431 is disposed corresponding to the data line D₂₁, so that the image control signal A₂₁ herein is the second driving signal A₄₁. The multiplexer 431 can transmit one of the voltage level signals A₆₁ to A₆₄ to the data line D₂₁ according to the second driving signal A₄₁ for determining the voltage level of the image signal transmitted by the data line D₂₁. When the transistor of the pixel unit 3₁₁ is enabled, the image signal transmitted by the data line D₂₁ can be written into the pixel unit 3₁₁, and the voltage level (e.g. 30V, −10V, 20V, or −5V) of the image signal can control the gray level of the displayed image.

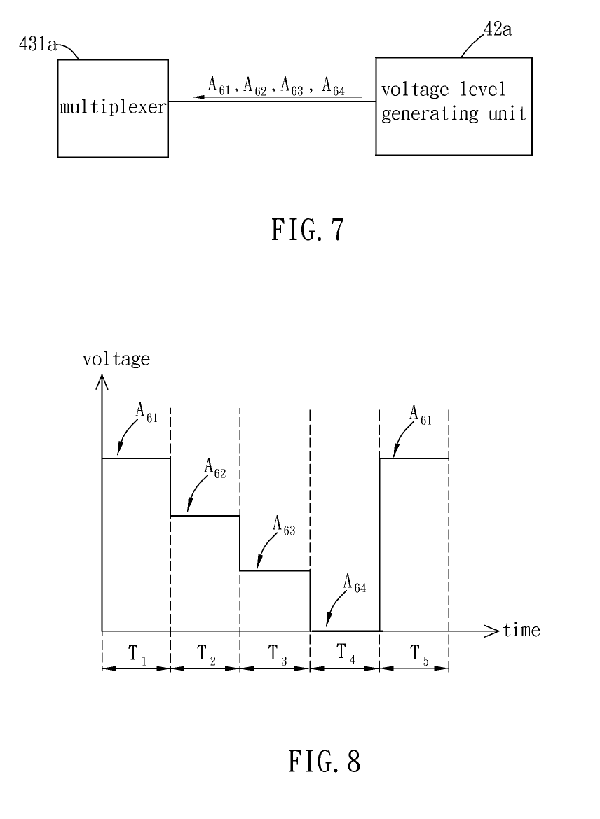

As mentioned above, the voltage level signals A₆₁ to A₆₄ are transmitted from the voltage level generating unit 42 to the multiplexer 431 through different output terminals or wires. Alternatively, as shown in FIG. 7, the voltage level signals A₆₁ to A₆₄ can be transmitted from the voltage level generating unit 42a to the multiplexer 431a through the same output terminal o wire. Referring to FIG. 8, the voltage level generating unit 42a can output the voltage level signals A₆₁ to A₆₄ at different timings, respectively, to the multiplexer 431a. For example, the voltage level signals A₆₁ is outputted at the timing T₁, the voltage level signals A₆₂ is outputted at the timing T₂, the voltage level signals A₆₃ is outputted at the timing T₃, and the voltage level signals A₆₄ is outputted at the timing T₄. After that, the voltage level signals A₆₁ to A₆₄ are repeatedly outputted. To be noted, the output order (or the values order of the voltage levels) of the voltage level signals A₆₁ to A₆₄ is not limited to the above example.

In practice, in order to efficiently decrease the total volume, at lease one part of the driving circuit 4 is manufactured by a single crystalline process and formed in an IC chip. Alternatively, at lease one part of the driving circuit 4 is manufactured by a polycrystalline process or an amorphous process and formed on the same substrate as the pixel units 3₁₁ to 3ₘₙ. In this case, the amorphous process can be an amorphous silicon thin-film-transistor process or an organic thin-film-transistor process. Of course, different manufacturing processes can be used. For example, the memory unit 41 can be formed on an IC chip by a single crystalline semiconductor process, the voltage level generating unit 42 and the voltage level selecting unit 43 can be formed on the same substrate as the pixel units 3₁₁ to 3ₘₙ by a polycrystalline process or an amorphous process. In brief, the memory unit 41, the voltage level generating unit 42 and the voltage level selecting unit 43 can be all configured in an integrated circuit; otherwise, only the memory unit 41 and the voltage level selecting unit 41 are configured in an integrated circuit. Herein, the integrated circuit can be a single crystalline integrated circuit.

In summary, the non-volatile display module and apparatus of the invention have a driving circuit, which includes a memory unit, a voltage level generating unit and a voltage level selecting unit, for processing the signals transmitted through the scan line and data line, thereby generating the displayed image. Compared with the prior art, the non-volatile display apparatus of the invention can not only integrate the conventional separated scan driving circuit and data driving circuit, but also use the driving circuit with simpler structure to process the signals transmitted through the scan line and the data line. Thus, the non-volatile display module and apparatus of the present invention can be manufactured with reduced amount of components, thereby decreasing the manufacturing cost.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A non-volatile display module, comprising:
a display panel comprising a substrate disposed with at least one scan line, at least one data line and at least one thin film transistor (TFT), wherein the TFT is located at an interlaced area of the scan line and the data line; and
a driving circuit comprising:
a memory unit receiving and storing at least one image control signal in accordance with a clock signal;
a voltage level generating unit generating a plurality of voltage-level signals; and
a voltage level selecting unit electrically connected with the scan line, the data line, the memory unit and the voltage level generating unit, wherein the voltage level selecting unit outputs one of the voltage-level signals to the scan line or the data line in accordance with the image control signal.

2. The non-volatile display module according to claim 1, wherein the memory unit comprises:
at least one shift register receiving the image control signal according to the clock signal; and
at least one latch electrically connected with the shift register and receiving the image control signal according to a latch signal.

3. The non-volatile display module according to claim 1, wherein the image control signal comprises a plurality of image signals and a plurality of scan signals.

4. The non-volatile display module according to claim 1, wherein the voltage level generating unit is a DC/DC voltage-level translator.

5. The non-volatile display module according to claim 1, wherein at least part of the non-volatile display module is manufactured by a single crystalline process, a polycrystalline process, or an amorphous process.

6. The non-volatile display module according to claim 1, wherein the memory unit, the voltage level generating unit and the voltage level selecting unit are configured in an integrated circuit.

7. The non-volatile display module according to claim 1, wherein the memory unit and the voltage level selecting unit are configured in an integrated circuit.

8. A non-volatile display apparatus, comprising:
a non-volatile display module comprising:
a display panel comprising a substrate disposed with at least one scan line, at least one data line and at least one thin film transistor (TFT), wherein the TFT is located at an interlaced area of the scan line and the data line; and
a driving circuit comprising:
a memory unit receiving and storing at least one image control signal in accordance with a clock signal;
a voltage level generating unit generating a plurality of voltage-level signals; and
a voltage level selecting unit electrically connected with the scan line, the data line, the memory unit and the voltage level generating unit, wherein the voltage level selecting unit outputs one of the voltage-level signals to the scan line or the data line in accordance with the image control signal.

9. The non-volatile display apparatus according to claim 8, wherein the memory unit comprises:
at least one shift register receiving the image control signal according to the clock signal; and
at least one latch electrically connected with the shift register and receiving the image control signal according to a latch signal.

10. The non-volatile display apparatus according to claim 8, wherein the image control signal comprises a plurality of image signals and a plurality of scan signals.

11. The non-volatile display apparatus according to claim 8, wherein the voltage level generating unit is a DC/DC voltage-level translator.

12. The non-volatile display apparatus according to claim 8, wherein at least part of the non-volatile display module is manufactured by a single crystalline process, a polycrystalline process, or an amorphous process.

13. The non-volatile display apparatus according to claim 8, wherein the memory unit, the voltage level generating unit and the voltage level selecting unit are configured in an integrated circuit.

14. The non-volatile display apparatus according to claim 8, wherein the memory unit and the voltage level selecting unit are configured in an integrated circuit.
